(19) United States
(12) Patent Application Publication
(10) Pub. No.: US 2005/0137299 A1
(43) Pub. Date: Jun. 23, 2005

(54) Polyester fibers, their production and their use

(75) Inventor: Kurt-Gunter Berndt, Graben (DE)

Correspondence Address: CONNOLLY BOVE LODGE & HUTZ, LLP, P O BOX 2207, WILMINGTON, DE, 19899, US

(73) Assignee: Teijin Monofilament Germany GmbH, Bobingen (DE)

(21) Appl. No.: 11/013,114

(22) Filed: Dec. 15, 2004

(30) Foreign Application Priority Data
Dec. 19, 2003 (DE) DE 103 59 763.8

(51) Int. Cl. C08K 5/15

(52) U.S. Cl. 524/114

(57) ABSTRACT

Described are polyester fibers having a free carboxyl group content of not more than 3 meq/kg which are stabilized by an epoxide composition comprising at least one epoxidized fatty acid ester having an epoxide content of not less than 1.5% by weight, based on the composition. The polyester fibers possess excellent hydrolytic stability and are useful for making products for the food-processing industry.

The present invention concerns polyester fibers having high hydrolysis resistance, especially monofilaments particularly useful in applications for food processing and/or storage.

It is known that polyesters fibers, especially monofilaments for industrial applications, are in most cases subjected to high mechanical and/or thermal stressors in use. In addition, there are in many cases stressors due to chemical and other ambient influences, to which the material has to offer adequate resistance. As well as adequate resistance to all these stressors, the material has to possess good dimensional stability and constancy of its stress-strain properties over very long use periods.

One example of industrial applications imposing that combination of high mechanical, thermal and chemical stresses is the use of monofilaments in filters, sieves or as conveyor belts. This use requires a monofilament material possessing excellent mechanical properties, such as high initial modulus, breaking strength, knot strength and loop strength, and also high abrasion resistance coupled with a high hydrolysis resistance in order that it may withstand high stresses encountered in its use and in order that the sieves or conveyor belts may have an adequate use life.

Molding compositions possessing high chemical and physical resistance and their use for fiber production are known. Polyesters are widely used materials for this purpose. It is also known to combine polymers with other materials, for example in order to achieve a specific degree of hydrolysis resistance.

Industrial manufacturers, such as food producer or processors, utilize filters or conveyor belts in operations taking place at elevated temperatures and in hot moist environments. Polyester-based manufactured fibers are approved for food-contact applications. When used in hot moist environments, however, polyesters tend to undergo hydrolytic degradation.

There have already been a number of attempts to control this disadvantageous characteristic of polyesters. One possible measure is to reduce the number of free carboxyl groups.

The capping of carboxyl groups with carbodiimides is known, for example from DE-A-39 30 845, DE-A-41 08 278, EP-A417,717 and EP-A-503,421.

U.S. Pat. No. 4,016,142 discloses reducing the level of free carboxyl groups in polyesters by addition of a glycidyl ether.

U.S. Pat. No. 4,284,540 describes polyethylene terephthalate molding compositions comprising a polyolefin copolymer, the glycidyl ester of an ethylenically unsaturated carboxylic acid and the barium salt of a long-chain fatty acid.

Prior art proposals lead to stabilized polyesters possessing excellent hydrolytic stability. However, the compounds used are problematical for food-contact applications.

Against the background of this prior art, the present invention has for its object to provide polyester fibers which possess excellent hydrolytic stability and which are useful for producing food-contact articles, such as conveyor belts or sieves.

The present invention now provides polyester fibers, especially monofilaments, which can be used in food processing and/or storage and which possess improved hydrolysis resistance compared with the unmodified polyester having the same number of carboxyl groups.

The invention accordingly provides polyester fibers having a free carboxyl group content of less than 3 meq/kg which are stabilized by an epoxide composition comprising at least one epoxidized fatty acid ester having an epoxide content of not less than 1.5% by weight, based on the composition.

Preference is given to polyester fibers having a free carboxyl group content of not more than 3 meq/kg which are stabilized by an epoxide composition comprising
a) epoxidized fatty acid esters and
b) epoxidized fatty acid glycerides,
   and having an epoxide content of not less than 1.5% by weight, based on the composition.

Any fiber-forming polyester can be used as long as it is formable in the melt and endows the fiber with properties desired for any one intended application.

These thermoplastic polyesters and/or aromatic liquid crystal polyesters are known per se.

Examples thereof are fiber-forming polyesters such as polycarbonate or aliphatic/aromatic polyesters, for example polybutylene terephthalate, polycyclohexane-dimethyl terephthalate, polyethylene naphthalate or especially polyethylene terephthalate, or else wholly aromatic, liquid crystal polyesters, such as polyoxy-benzonaphthoate. Building blocks of fiber-forming polyesters dicarboxylic acids or appropriately constructed hydroxyl carboxylic acids. The main acid constituent of polyesters is terephthalic acid or cyclohexanedicarboxylic acid, but other aromatic and/or aliphatic or cycloaliphatic dicarboxylic acids may be suitable as well, preferably para- or trans-disposed aromatic compounds, for example 2,6-naphthalenedicarboxylic acid or 4,4′-biphenyldicarboxylic acid, but also p-hydroxybenzoic acid. Aliphatic dicarboxylic acids, such as adipic acid or sebacic acid for example, are preferably used in combination with aromatic dicarboxylic acids.

Useful dihydric alcohols typically include aliphatic and/or cycloaliphatic and/or aromatic diols, for example ethylene glycol, propanediol, 1,4-butanediol, 1,4-cyclohexanedimethanol or else hydroquinone. Preference is given to aliphatic diols which have two to four carbon atoms, especially ethylene glycol; preference is further given to cycloaliphatic diols, such as 1,4-cyclohexanedimethanol.

Preference is given to using polyesters comprising structural repeat units derived from an aromatic dicarboxylic acid and an aliphatic and/or cycloaliphatic aliphatic diol.

Preferred thermoplastic polyesters are especially selected from the group consisting of polyethylene terephthalate, polyethylene naphthalate, polybutylene naphthalate, polypropylene terephthalate, polybutylene terephthalate, polycyclohexanedimethanol terephthalate, polycarbonate or a copolycondensate comprising polybutylene glycol, terephthalic acid and naphthalenedicarboxylic acid units.

Further preferred thermoplastic polyesters are aromatic, liquid crystal polyesters, especially polyesters comprising p-hydroxybenzoate units.

The shaped polyester articles stabilized according to the present invention exhibit a significant reduction in the degradation tendency of the polyester, making it possible for example to achieve monofilament lives which are equivalent to those of monofilaments based on extremely stable fibrous materials, such as polyarylene sulfides or oxides.

The polyesters used according to the present invention typically have solution viscosities (IV values) of not less than 0.60 dl/g, preferably of 0.60 to 1.05 dl/g and more preferably of 0.62-0.93 dl/g (measured at 25° C. in dichloroacetic acid).

The hydrolysis control agents used according to the present invention endow polyester fibers with excellent hydrolysis control without being toxic.

The hydrolysis control agents used according to the present invention can be produced by simply mixing the components together.

The epoxidized fatty acid esters used as hydrolysis control agents used according to the present invention are derived from any desired fatty acids esterified with any desired, preferably aliphatic, alcohols.

The number of carbon atoms in the fatty acids is preferably in the range from six to thirty and especially in the range from ten to twenty. The epoxidized fatty acid esters used for producing the hydrolysis control agents used according to the present invention have at least one double bond. This double bond can be situated in the alcohol moiety or preferably in the acid moiety. It is also possible to use fatty acid esters having plural double bonds as starting materials. These compounds are in particular esters of omega-fatty acids, which occur in fish oils for example. The alcohols can be tertiary, secondary or primary aliphatic alcohols and generally have from one to ten carbon atoms.

Preferred hydrolysis stabilizers comprise a) epoxidized fatty acid alkyl esters and b) epoxidized fatty acid glycerides.

The epoxidized fatty acid glycerides used as component b) are derived from any desired fatty acids wholly or partially esterified with glycerol. The number of carbon atoms in the fatty acids is preferably in the range from six to thirty and especially in the range from ten to twenty. The fatty acids are preferably unsaturated and may have one or more double bonds.

Epoxidized fatty acid glycerides particularly useful for producing the hydrolysis control agents used according to the present invention include epoxidized soybean oil, epoxidized linseed oil, epoxidized colza oil, epoxidized sunflower oil and epoxidized fish oil.

As epoxidized fatty acid esters it is preferable to use the thermally stable C₁-C₈-alkyl esters, especially the 2-ethylhexyl esters, of unsaturated fatty acids or fatty acid mixtures of the fatty acids underlying colza oil, linseed oil, soybean oil or fish oil.

The epoxidized products can be prepared by conventional epoxidation of the appropriate starting materials (esters or glycerides) with per-compounds, such as peracids or hydrogen peroxide, or with activated oxygen, for example with ozone.

The epoxide content of the hydrolysis stabilizer used according to the present invention can likewise vary within wide limits, but is preferably not less than 1.5% by weight with regard to oxygen, based on the total amount of epoxidized components. The epoxide content is preferably in the range from 1.5% to 15% by weight and especially in the range from 4% to 8% by weight.

The quantitative ratio of component a) to b) can vary within wide limits. Typically, the amount of component a) is in the range from 90% to 10% by weight and the amount of component b) in the range from 10% to 90% by weight, based on the total amount of components a) and b).

Identity and amount of components a) and b) are preferably chosen such that liquid products are obtained.

Preferably, the hydrolysis control agent used according to the present invention further comprises at least one carbodiimide as component c).

In this embodiment, the hydrolysis control agent preferably comprises from 90% to 10% by weight of component a), from 9.9% to 60% by weight of component b) and from 0. 1 % to 30% by weight of component c) (based on the total amount of components a) to c)).

The NCN content here is not less than 2.0% by weight, based on the total amount of components a) to c).

Particular preference is given to using a hydrolysis control agent which consists exclusively of components a) and b).

The amount of epoxide composition added in the course of the production of the polyester fibers according to the present invention or in the course of the production of the polyester is to be chosen such as to produce the desired free carboxyl group content level of 0 to 3 meq/kg and preferably of not more than 2 meq/kg of polyester.

The amount of epoxide composition can be chosen such that virtually all epoxide groups will have been consumed after the desired free carboxyl group content has been set.

Preferably, however, larger amounts will be used in order that a depot action may be achieved.

The amount of epoxide composition is typically in the range from 0.05% to 30% by weight, based on the polyester fiber. Preference is given to using from 0. 1% to 10% by weight.

By polyester fibers, as used herein, are meant any desired polyester fibers.

Examples thereof are filaments or staple fibers which consist of plural individual fibers, but especially are monofilaments.

The polyester fibers of the present invention can be produced by conventional processes.

The present invention also provides a process for producing the polyester fibers according to the present invention, the process comprising the measures of:
i) mixing polyester pellet with the epoxide composition defined above, and
ii) extruding the mixture comprising polyester and epoxide composition through a spinneret die, and
iii) withdrawing the resulting filament.

Here, the amount of epoxide composition is to be chosen such that the level of free carboxyl groups in the polyester fiber does not exceed 3 meq/kg.

The present invention further provides a process for producing the polyester fibers according to the present invention, the process comprising the measures of:
iv) feeding an extruder with polyester mixed with the epoxide composition defined above before or during the polycondensation, and
ii) extruding the mixture comprising polyester and epoxide composition through a spinneret die, and
iii) withdrawing the resulting filament.

In this variant too the amount of epoxide composition is to be chosen such that the level of free carboxyl groups in the polyester fiber does not exceed 3 meq/kg.

In a preferred embodiment of the processes according to the present invention the polyester filament formed is subjected to single or multiple drawing.

The polyester fibers of the present invention can be present in any desired form, for example as multifilaments, as staple fibers or especially as monofilaments.

The linear density of the polyester fibers according to the present invention can likewise vary within wide limits. Examples thereof are 100 to 45 000 dtex and especially 400 to 7000 dtex.

Particular preference is given to monofilaments whose cross-sectional shape is round, oval or n-gonal, where n is not less than 3.

The polyester fibers according to the present invention can be produced using a commercially available polyester raw material. A commercially available polyester raw material will typically have a free carboxyl group content in the range from 15 to 50 meq/kg of polyester. Preference is given to using polyester raw materials produced by solid state condensation; their free carboxyl group content is typically in the range from 5 to 20 meq/kg and preferably less than 8 meq/kg of polyester.

However, the polyester fibers of the present invention can also be produced using an already hydrolysis-stabilized polyester raw material. It was produced by adding the stabilizer mixture comprising components a) and b) during the polycondensation and/or to at least one of the monomers. This polyester raw material will have a carboxyl group content of not more than 3 meq/kg before fiber production.

After the polyester melt has been forced through a spinneret die, the hot strand of polymer is quenched, for example in a quench bath, preferably in a water bath, and subsequently wound up or taken off. The takeoff speed is greater than the ejection speed of the polymer melt.

The polyester fiber thus produced is subsequently preferably subjected to an afterdrawing operation, more preferably in plural stages, especially to a two- or three-stage afterdrawing operation, to an overall draw ratio in the range from 3:1 to 8:1 and preferably in the range from 4:1 to 6:1.

Drawing is preferably followed by heat setting, for which temperatures in the range from 130 to 280° C. are employed; length is maintained constant or shrinkage of up to 30% is allowed.

It has been determined to be particularly advantageous for the production of the polyester fibers of the present invention to operate at a melt temperature in the range from 285 to 315° C. and at a jet stretch ratio in the range from 2: 1 to 6: 1.

The takeoff speed is customarily 10-100 m per minute and preferably 1 - 40 m per minute.

The polyester fibers of the present invention may comprise further auxiliaries in addition to the hydrolysis stabilizer. Examples of further auxiliaries are processing aids, antioxidants, plasticizers, lubricants, pigments, delusterants, viscosity modifiers or crystallization accelerants.

Examples of processing aids are siloxanes, waxes or long-chain carboxylic acids or their salts, aliphatic, aromatic esters or ethers.

Examples of antioxidants are phosphorus compounds, such as phosphoric esters, or sterically hindered phenols.

Examples of pigments or delusterants are organic dye pigments or titanium dioxide.

Examples of viscosity modifiers are polybasic carboxylic acids and their esters or polyhydric alcohols.

The polyester fibers of the present invention are used in particular for producing articles used in food processing and/or storage.

The polyester fibers of the present invention are preferably used for producing sheetlike structures, especially wovens, used in the food-processing industry.

A further use of the polyester fibers according to the present invention in the form of monofilaments concerns their use as conveyor belts or as components of conveyor belts in the food-processing industry.

These uses likewise form part of the subject matter of the present invention.

The examples which follow illustrate the invention without limiting it.

Polyethylene terephthalate (PET) and hydrolysis stabilizer were mixed in an extruder, melted and spun through a 12 hole spinneret die having a hole diameter of 1.10 mm and at a feed rate of 292.3 g/min and a takeoff speed of 32.7 m/min to form monofilaments, doubly drawn (first drawing in water bath at 80° C.; second drawing in water bath at 90° C.) and also heat set in a hot air duct at 235° C. The overall draw ratio was 4.28:1. The final diameter of the filaments was 0.40 mm.

The PET used was a solid state condensed type having a free carboxyl group content of about 7 meq/kg.

The hydrolysis stabilizer used was a mixture of epoxidized fatty acid alkyl esters and epoxidized fatty acid glycerides (Synbio Hystab experimental product from Schäfer-Additivsysteme GmbH, Slevogtweg 10, 67122 Altrip).

The table which follows summarizes the dosages used in the individual runs, the free carboxyl group content of the stabilized product and also the retained strength after an 80 hour treatment in a hot moist environment at 135° C. (hydrolysis resistance).

| | Amount of | Level of free | Strength | Strength | |
|---|---|---|---|---|---|
| | hydrolysis | carboxyl | prior to | after 80 h | Retained |
| | stabilizer | groups | hydrolysis | in saturated steam | strength after |
| Example No. | [% by weight] | [meq/kg] | test [N] | at 135° C. [N] | hydrolysis [%] |
| Comparison 1 | — | 7 | 66.7 | —¹⁾ | 0 |
| Comparison 2 | 0.5 | 4 | 67.0 | —¹⁾ | 0 |
| 1 | 1.0 | 3 | 65.4 | 12.7 | 19 |
| 2 | 1.5 | <2 | 63.3 | 17.7 | 28 |
| 3 | 2.0 | <2 | 63.0 | 16.5 | 26 |
| 4 | 2.5 | <2 | 62.1 | 16.9 | 27 |

¹⁾indicates “not measurable”; the monofilament is brittle and disintegrates

1. Polyester fibers having a free carboxyl group content of not more than 3 meq/kg which are stabilized by an epoxide composition comprising at least one epoxidized fatty acid ester having an epoxide content of not less than 1.5% by weight, based on the composition.

2. The polyester fibers according to claim 1 wherein the epoxide composition comprises
a) epoxidized fatty acid esters, and
b) epoxidized fatty acid glycerides,
and has an epoxide content of not less than 1.5% by weight, based on the composition.

3. The polyester fibers according to claim 2 wherein the epoxide composition consists of
a) 90% to 10% by weight of long-chain epoxidized fatty acid alkyl esters and
b) 10% to 90% by weight of epoxidized fatty acid glycerides,
and has an epoxidized epoxide content of not less than 1.5% by weight.

4. The polyester fibers according to claim 1 wherein the epoxide composition comprises
a) 90% to 10% by weight of long-chain epoxidized fatty acid alkyl esters,
b) 9.9% to 60% by weight of epoxidized fatty acid glycerides and
c) 0.1% to 30% by weight of carbodimides,
and has an epoxide content of not less than 1.5% by weight and an NCN group content of not less than 2.0% by weight.

5. The polyester fibers according to claim 1 wherein the amount of epoxide composition is in the range from 0. 1% to 10% by weight, based on the shaped polyester article.

6. The polyester fibers according to claim 1 wherein the fiber is a monofilament.

7. The polyester fibers according to claim 1 wherein the polyester comprises structural repeat units derived from an aromatic dicarboxylic acid and an aliphatic and/or cycloaliphatic diol.

8. The polyester fibers according to claim 1 wherein the polyester is a liquid crystal polyester.

9. A process for producing the polyester fibers according to claim 1, the process comprising the steps of:
i) mixing polyester pellet with the epoxide composition according to claim 1,
ii) extruding the mixture comprising polyester and epoxide spinneret die, and
iii) withdrawing the resulting filament,
with the proviso that the amount of epoxide composition is chosen such that the level of free carboxyl groups in the polyester fiber does not exceed 3 meq/kg.

10. A process for producing the polyester fibers according to claim 1, the process comprising the steps of:
i) feeding an extruder with polyester pellet mixed with the epoxide composition according to claim 1 before or during polycondensation, and
ii) extruding the mixture comprising polyester and epoxide composition through a spinneret die, and
iii) withdrawing the resulting filament,
with the proviso that the amount of epoxide composition is chosen such that the level of free carboxyl groups in the polyester fiber does not exceed 3 meq/kg.

11. The process according to claim 10 wherein the polyester fiber is subjected to single or multiple drawing.

12. The process according to claim 10 wherein the polyester fiber is produced using a polyester produced by solid state condensation.

13-15. (canceled)

16. The polyester fibers according to claim 1 wherein the polyester comprises polyethylene terephthalate repeat units.

17. An article useful for food processing or food storage comprising the polyester fibers of claim 1.

18. A woven sheetlike structure, useful for food processing or storage, comprising the polyester fibers of claim 1.

19. A conveyor belt comprising the polyester fiber according to claim 1 in the form of mono filaments.
